(19) United States
(12) Patent Application Publication
(10) Pub. No.: US 2015/0083914 A1
(43) Pub. Date: Mar. 26, 2015

(54) RAILWAY REFERENCE MACHINE HAVING A COLLAPSIBLE PROJECTOR ASSEMBLY

(71) Applicant: Nordco Inc., Oak Creek, WI (US)

(72) Inventor: David A. Spence, Hartland, WI (US)

(21) Appl. No.: 14/490,312

(22) Filed: Sep. 18, 2014

Related U.S. Application Data
(60) Provisional application No. 61/882,137, filed on Sep. 25, 2013.

(51) Int. Cl. G01B 11/27; E01B 35/00

(52) U.S. Cl. CPC G01B 11/272; E01B 35/00
USPC 250/338.1; 250/493.1

(57) ABSTRACT

A railway reference machine is provided for surveying and aligning a railroad track, and includes a collapsible projector assembly having a pusher buggy assembly, and a lifting device. A plurality of projectors is mounted to a projector cart. The pusher buggy assembly has extendable and retractable linkage sections such that the linkage sections are stackable and nestable within a space defined by the lifting device and the projector cart. At one end, the pusher buggy assembly is connected to the projector cart and at an opposite end is connected to the lifting device such that the projector cart pivots upwardly about a pivot point to rest the projector assembly in a space defined by a chassis being dimensional for supporting the reference machine, and pivots downwardly about the pivot point to lower the projector assembly on the railroad track.

### CROSS-REFERENCE

This application claims priority under 35 USC 119(e) from U.S. Provisional Application Ser. No. 61/882,137 filed Sep. 25, 2013.

### BACKGROUND

The present disclosure generally relates to railroad right-of-way maintenance machinery, and more particularly relates to machinery used for surveying and aligning a railroad track using a high frequency beam such as an infrared signal.

During construction of a railroad, a bed of gravel or ballast is constructed and formed typically between one and three feet thick. Railroad ties are embedded in the ballast and rails are attached to the ties via tie plates. In the case of wooden railroad ties, the rails are nailed to the ties with spikes, but in the case of concrete ties, clips connect the rails and the ties. All rails and ties must be set at a specific height and alignment. For example, the rails must be disposed at a certain height above the ballast and stay within pre-set tolerances with respect to the alignment.

A tamping machine known as a ballast tamper is generally equipped with a railway reference machine for surveying the track, and the tamper is used to lift the rails and ties based on the survey such that the ties can be set at the specific height and properly aligned vertically and laterally. Reference or survey points established during the design phase of the railroad track are used to determine what the proper position and depth of the rail and ties should be. Through extended use, the rails become misaligned as the gravel and ballast sink into the ground. Such sinking is not consistent through the length of the railroad. Accordingly, the reference machine is periodically used to realign the rails based on the reference points.

For accuracies of the reference points, a buggy having infrared projectors is moved to about 100 feet away from the reference machine, and positioned on reliable reference rails for projecting infrared beams to sensors or receivers mounted to the reference machine A shadow board on the reference machine is provided in operational relationship to the projectors and the receivers for establishing proper alignment and position of the rails and tracks.

However, the projector buggy is a separate unit from the reference machine and must be placed far away from the reference machine. An operator of the machine periodically needs to reposition the projector buggy to a proper position. This requires manual adjustment of the projector buggy to a desired point. In some cases, the projector buggy is positioned at the end of a tunnel or on top of a bridge. Not only is this frequent repositioning of the projector buggy time consuming and laborious, but also is very inconvenient and costly. Therefore, there is a need for an improved projector buggy that can travel with the reference machine and is automatically deployed when necessary without much manual intervention of the operator.

### SUMMARY

The present disclosure is directed to a railway reference machine having a collapsible projector assembly and a tamping machine, which is used for surveying and aligning a railroad track. Specifically, the collapsible projector assembly can be stored on a frame of the reference machine when not in use. More specifically, a foldable pusher buggy assembly is provided that rests within a space defined by the frame during transportation of the machine on a highway or a railroad track. Transporting the projector assembly both on the highway and the track is possible by utilizing a roadworthy tamper apparatus. An exemplary transportation of the tamping machine is shown in our co-pending U.S. patent application Ser. No. ______ filed on ______ (Attorney Docket 1425.114261), which is incorporated by reference.

One aspect of the reference machine is that, as described in further detail below, the projector assembly includes the pusher buggy assembly having extendable and retractable linkage sections such that the linkage sections of the pusher buggy assembly are stackable and nestable within a confined area on the frame. A projector cart is attached to one end of the pusher buggy assembly, and a lifting device, such as a fork lift, is attached to the other end of the pusher buggy assembly for pivotally raising the buggy assembly onto the frame for storage.

Another important aspect is that the linkage sections are connected to each other via a linkage lock assembly. Included in the lock assembly are a locking mechanism and a cushioning mechanism interposed between adjacent ends of the linkage sections. Automatic locking of the adjacent linkage sections is achieved when the linkage sections are fully extended, but the locking mechanism can be released manually when the surveying and aligning of the rails are completed and the pusher buggy assembly needs to be folded and stowed away. For allowing the pusher buggy assembly to travel through curves and/or spirals on the railroad track, the cushioning mechanism is provided with a compliant joint to accommodate vibrations or movements caused by the geometry of the track during operation.

In one embodiment, a railway reference machine is provided for surveying and aligning a railroad track, and includes a collapsible projector assembly having a pusher buggy assembly, and a lifting device. A plurality of projectors is mounted to a projector cart. The pusher buggy assembly has extendable and retractable linkage sections such that the linkage sections are stackable and nestable within a space defined by the lifting device and the projector cart. At one end, the pusher buggy assembly is connected to the projector cart and at an opposite end is connected to the lifting device such that the projector cart pivots upwardly about a pivot point to rest the projector assembly in a space defined by a chassis being dimensional for supporting the reference machine, and pivots downwardly about the pivot point to lower the projector assembly on the railroad track.

In another embodiment, a railway reference machine is provided for surveying and aligning a railroad track, and includes a collapsible projector assembly including a projector cart having at least one projector, a pusher buggy assembly, and a lifting device. The pusher buggy assembly transitions between a retracted mode and an extended mode. The retracted mode refers to a condition where the pusher buggy assembly is folded and securely stored on a base plate of the projector cart, and the extended mode refers to a condition where the pusher buggy assembly is unfolded on the railroad track. At one end, the pusher buggy assembly is connected to the projector cart and at an opposite end is connected to the lifting device such that the projector cart pivots upwardly about a pivot point to rest the projector assembly in a space defined by a chassis being dimensional for supporting the reference machine, and pivots downwardly about the pivot point to lower the projector assembly on the railroad track.

In still another embodiment, a railway reference machine is provided for surveying and aligning a railroad track, and includes a collapsible projector assembly including a projector cart having at least one projector, a pusher buggy assembly, and a lifting device. The pusher buggy assembly is folded and securely stored on a base plate of the projector cart for storage or transportation, and is unfolded on the railroad track for operation. At one end, the pusher buggy assembly is connected to the projector cart and at an opposite end is connected to the lifting device such that the projector cart pivots upwardly about a pivot point to rest the projector assembly in a space defined by a chassis being dimensional for supporting the reference machine, and pivots downwardly about the pivot point to lower the projector assembly on the railroad track. A shadow board buggy has an adjustable shadow board being located between the projector assembly and a rearwardly located receiver buggy having at least one receiver for detecting misalignment of the track. A pair of surfacing receiver is provided for detecting vertical misalignments of rails, and a pair of lining receivers is provided for detecting horizontal misalignments of the rails.

### BRIEF DESCRIPTION OF THE DRAWINGS

FIG. 1 is a fragmentary perspective view of the present railway reference machine when a projector assembly is in a retracted mode upon a railway tamper machine;

FIG. 2 is a fragmentary perspective view of the railway reference machine of FIG. 1 when the projector assembly is in an extended mode;

FIG. 3 is a fragmentary side view of the projector assembly in a road travel mode;

FIG. 4 is a fragmentary side view of the projector assembly in a track travel mode;

FIG. 5 is a top perspective view of a pusher buggy assembly in a locked position;

FIG. 6 is an enlarged perspective view of a portion of the pusher buggy assembly of FIG. 5 in an unlocked position;

FIG. 7 is a perspective view of the present travel lock;

FIG. 8 is an enlarged fragmentary perspective view of the present locking pin of the travel lock of FIG. 7;

FIG. 9 is a perspective view of the present linkage lock assembly;

FIG. 10 is an enlarged view of a compliant joint of the linkage lock assembly of FIG. 9;

FIG. 11 is a perspective view of the compliant joint of FIG. 10;

FIG. 12 is a fragmentary perspective view of the present shadow board buggy;

FIG. 13 is a fragmentary enlarged view of the present shadow board in a work position;

FIG. 14 is a fragmentary enlarged view of the shadow board of FIG. 13 in a travel position;

FIG. 15 is a fragmentary enlarged view of the present biasing wheels assembly;

FIG. 16 is a fragmentary perspective view of the present receiver buggy;

FIG. 17 is a fragmentary perspective view of the receiver buggy of FIG. 16 in a retracted position;

FIG. 18 is a fragmentary perspective view of the receiver buggy of FIG. 16 in an extended position;

FIG. 19 is a top perspective view of a lining receiver with a quick-release assembly;

FIG. 20 is an enlarged view of the quick-release assembly of FIG. 19; and

FIG. 21 is a cross-sectional view of the quick-release assembly of FIG. 20 taken along the line A-A and in the direction generally indicated.

### DETAILED DESCRIPTION

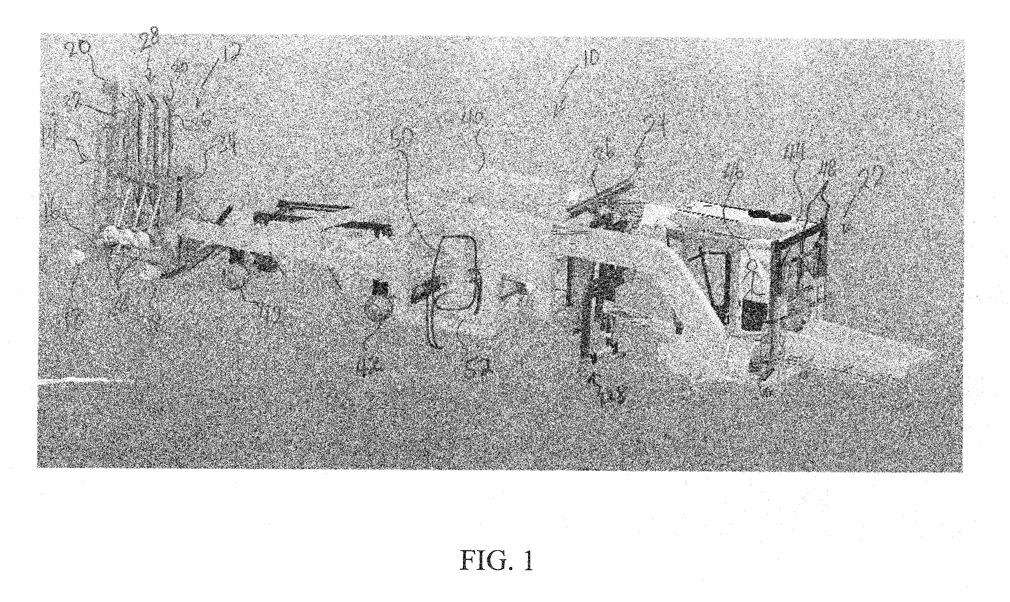

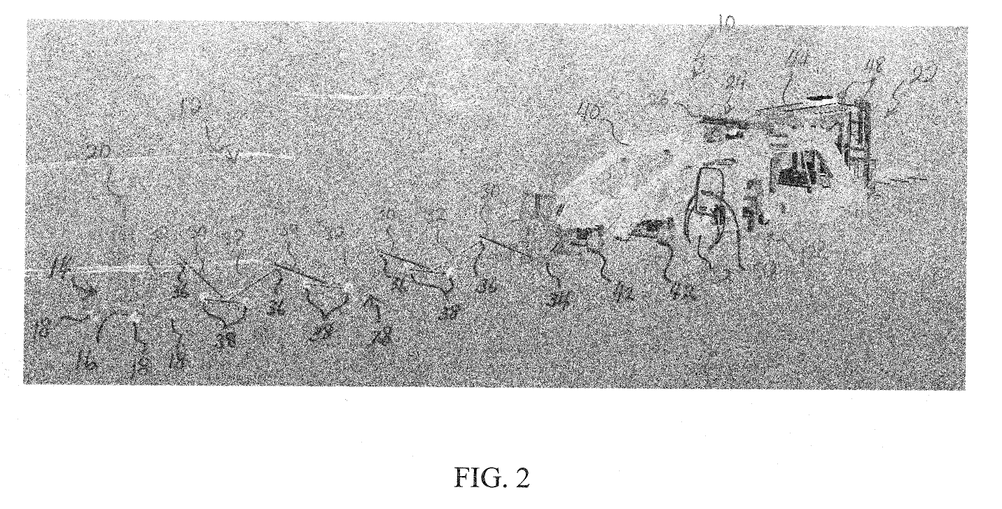

Referring now to FIGS. 1-2, the present railway reference machine is generally designated 10, and is constructed to survey and align a railroad track using a collapsible projector assembly, generally designated 12. As is well known in the art, the reference machine 10 is designed to be self-propelled or towed as a separate unit along the railroad track. While it is preferred that the reference machine 10 is self-propelled, a towed reference machine is also contemplated. It is also contemplated that the present reference machine 10 is incorporated into a rail tamper apparatus, as described in our co-pending U.S. patent application Ser. No. ______ filed on ______ (Attorney Docket 1425.114261), which is incorporated by reference.

Included in the projector assembly 12 is a projector cart, generally designated 14, having a cart frame 16 supported by a plurality of cart wheels 18 for traveling on the track. At least one high frequency beam transmitter or projector 20 is carried by the projector cart 14 and mounted to the cart frame 16 for projecting an infrared signal to a rearwardly located receiver buggy, generally designated 22. A shadow board buggy, generally designated 24, is located between the projector assembly 12 and the receiver buggy 22. An adjustable shadow board 26 is mounted to the shadow board buggy 24 and is provided in operational relationship to the projector assembly 12 and the receiver buggy 22 to indicate whether the track is out of alignment vertically and/or horizontally.

Also included in the projector assembly 12 is a pusher buggy assembly, generally designated 28, having a first linkage section 30 and a second linkage section 32. At one end, the pusher buggy assembly 28 is connected to the projector cart 14 and at an opposite end is connected to a lifting device 34. Both linkage sections 30, 32 are connected to each other and cause them to pivotally fold about pivot points 36. For example, the first linkage section 30 is pulled toward the second linkage section 32, thereby shortening the distance between the two sections 30, 32. This folding action causes the first and second sections 30, 32 to move inwardly toward each other, and as a result the sections are movably or slidably collapsed for storage. Each second linkage section 32 has a pair of pusher wheels 38 for traveling on the railroad track.

A chassis 40 supporting the reference machine 10 is attached to the lifting device 34 and is also dimensional for supporting the projector assembly 12, the receiver buggy 22, and the shadow board buggy 24. A plurality of chassis wheels 42 are provided for traveling on the railroad track. A cab 44 accessible by an operator 46 includes various control mechanisms for the reference machine 10, and is located between the receiver buggy 22 and the shadow board buggy 24.

To perform an accurate survey of the alignment of the rails, the projector cart 14 is typically positioned more than 100 feet in front of the receiver buggy 22. Positioning of the projector cart 14 is achieved by unfolding and stretching the pusher buggy assembly 28 along the railroad track. As described in further detail below, the pusher buggy assembly 28 is extendable and retractable such that multiple first and second linkage sections 30, 32 are stackable upon and nestable within the lifting device 34.

Once the pusher buggy assembly 28 is fully extended, reaching a predetermined position from the receiver buggy 22, an infrared light is transmitted from the projector 20 towards at least one receiver 48 mounted to the receiver buggy 22. Three elements, namely the projector 20, the shadow board 26, and the receiver 48, communicate with one another to establish a reference line, and the elements act as a detection system to correct the track alignment relative to the reference line.

A built-in error may exist in the correction to the rails. For example, when the projector cart 14 is positioned approximately 120 feet from the receiver buggy 22, assuming that there is approximately a 14.5 feet spacing between the shadow board buggy 24 and the receiver buggy 22, there is a 7:1 error correction ratio. Thus, if the projector 20 is within a seven inch depth of track of the reference machine 10, a tamper machine 50 (shown in phantom) installed within a work area 52 defined by the chassis 40 creates a one-inch depth from a desired height.

In other words, the tamper machine 50 lifts the rails until the rails are at a specific height so that the projector 20 can communicate with the receiver 48 before the shadow board 26 comes into alignment and indicates that the rails are set at the proper error tolerance level. Once the tamper machine 50 has lifted and aligned the rails to the desired position, the tamper unit in the machine moves the ballast to support the rails in the now-aligned position as is well known in the art. Then, the projector cart 14 is repositioned on the track for subsequent alignments.

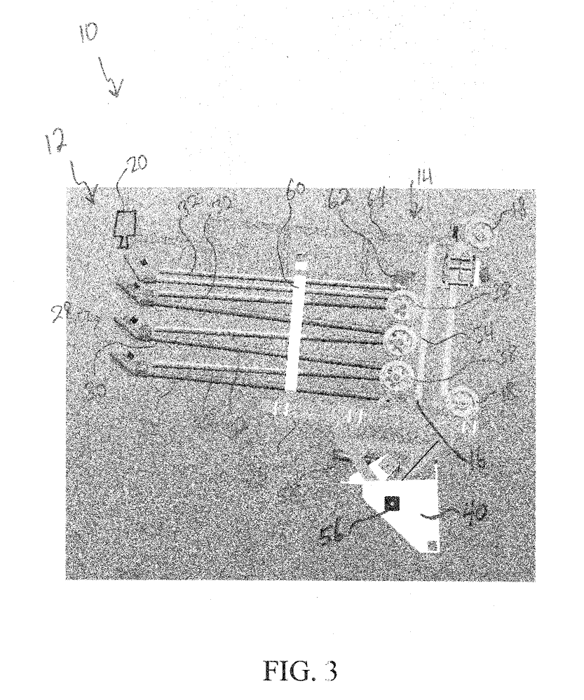

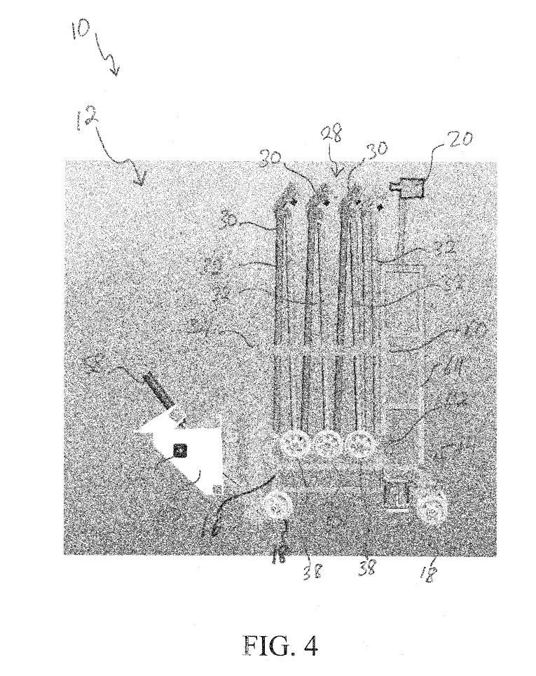

Referring now to FIGS. 1-4, an important feature of the projector assembly 12 is that it can be collapsed and stowed away for transportation and/or storage. Specifically, FIG. 1 shows the projector assembly 12 in a retracted mode. As shown in FIGS. 3-4, the retracted mode refers to a condition where the pusher buggy assembly 28 is folded and securely stored on a base plate 54 of the projector cart 14 for traveling on a highway or on a railroad track. For example, when in the retracted mode, the projector assembly 12 can either be stowed away for storage and/or transportation on a road, such as a state highway, or on the railroad track using the cart wheels 18. Additionally, FIG. 2 shows the projector assembly 12 in an extended mode. The extended mode refers to a condition where the pusher buggy assembly 28 is unfolded and the first and second linkage sections 30, 32 are securely locked so that the projector cart 14 reaches a predetermined position from the receiver buggy 22.

More specifically, FIGS. 3 and 4 illustrate the projector assembly 12 in road and track travel modes, respectively. As shown in FIG. 3, the road travel mode refers to a condition where the folded pusher buggy assembly 28 is stored in a space defined by the lifting device 34, the base plate 54 and the projector cart 14 while being transported on the highway. To secure clearance from the track, the lifting device 34 holding the folded pusher buggy assembly 28 and the projector cart 14 pivots upwardly about a pivot bar 56 at an angle of about 90 degrees toward the cab 44 (FIGS. 1-2), and rests in a space defined by the chassis 40. As a result, when the projector assembly 12 is being transported on the highway by the roadworthy tamper apparatus, e.g., as taught in the U.S. application Ser. No. ______ (Attorney Docket 1425.114261), the first and second linkage sections 30, 32 lie substantially in parallel relative to the rails.

A lifting cylinder 58, preferably a hydraulic actuator, is used for the pivoting movement, and is connected at one end to the lifting device 34 and at an opposite end to the chassis 40. During the pivoting movement, the folded pusher buggy assembly 28 is secured by at least one holding bar 60 and/or at least one travel lock 62. While the holding bar 60 is connected at one end to the lifting device 34 and at an opposite end to the projector cart 14, the travel lock 62 is connected at one end to a stand structure 64 of the projector cart 14 and at an opposite end to the cart frame 16.

As shown in FIG. 4, the track travel mode refers to a condition where the folded pusher buggy assembly 28 is still stored on the base plate 54 as in the road travel mode, but the projector cart 14 is lowered and movable on the track for transportation. Specifically, the lifting device 34 pivots downwardly about the pivot bar 56 at an angle of about 90 degrees toward the railroad track so that the cart wheels 18 engage the rail heads for traveling on the track. When the reference machine 10 reaches a desired work site on the track, the pusher buggy assembly 28 is lowered by the lifting device 34 on the rails for deployment.

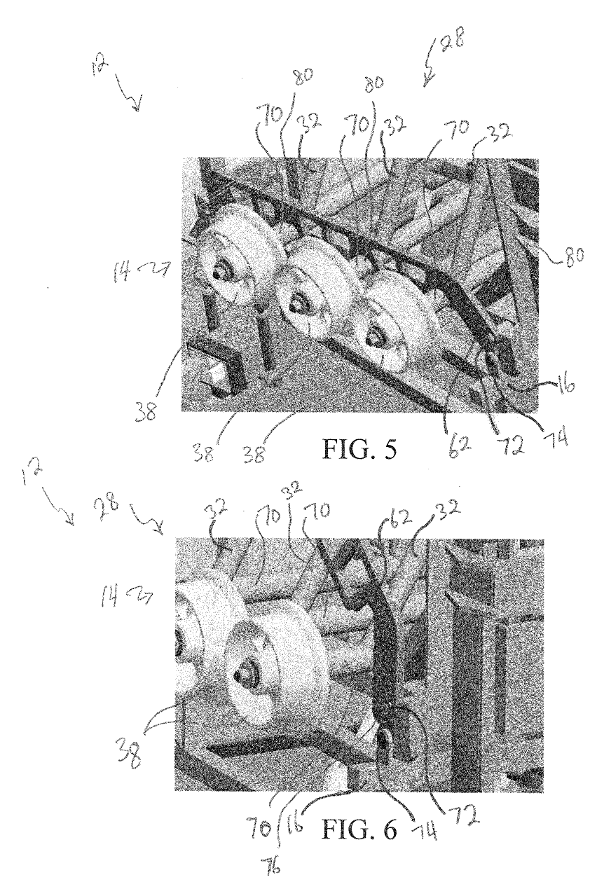

Referring now to FIGS. 5-8, all pusher wheels 38 located on the same side, either right or left, are releasably collectively locked by the travel lock 62 to prevent movement during transportation and/or storage. A plurality of indentations 66 are defined on a lower edge 68 of the travel lock 62, and each indentation 66 matingly biases an axle 70 connected to a pair of pusher wheels 38 of each second linkage section 32. To place the pusher buggy assembly 28 in a locked position, the travel lock 62 pivots downwardly about a lock pivot pin 72, capturing a locking pin 74 mounted to the cart frame 16 with a protrusion portion 76 of the travel lock 62 to secure the position. Conversely, to place the pusher buggy assembly 28 in an unlocked position, the travel lock 62 pivots upwardly about the lock pivot pin 72, thereby releasing the locking pin 74. When the travel lock 62 releases the pusher wheels 38, the projector cart 14 is also released and subsequently the pusher buggy assembly 28 can be unfolded.

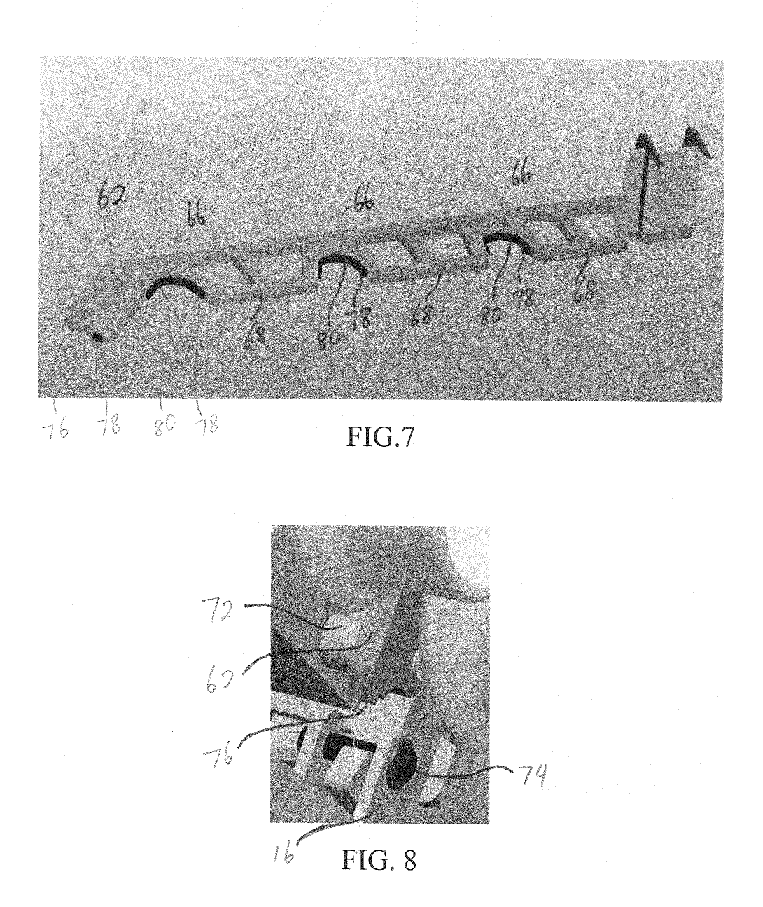

As best shown in FIG. 7, a plurality of shock absorbing pads 78, such as neoprene pads, is provided to dampen shocks occurring at various mating sites 80, namely between the axles 70 and corresponding indentations 66, and also between the cart frame 16 and the travel lock 62. As a result, the shock absorbing pads 78 provides consistent contact between the travel lock 62 and the axles 70 to prevent unnecessary movement during transportation of the projector assembly 12. While only the mating sites 80 between the axles 70 and the indentations 66 are shown, other similarly situated sites causing abrasions or movements are also contemplated.

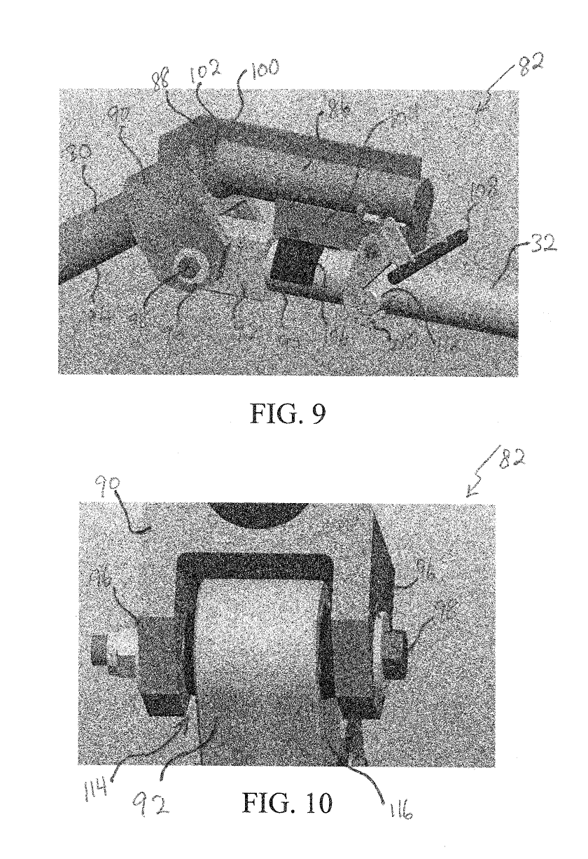

Referring now to FIGS. 2 and 9, an exemplary linkage lock assembly, generally designated 82 (FIG. 9), is shown. The linkage lock assembly 82 firmly secures the first and second linkage sections 30, 32 to ensure and maintain a constant distance between the linkage sections from one end of the first linkage section 30 to the other opposite end of the second linkage section 32 when fully extended. In the preferred embodiment, the first linkage section 30 has an elongated portion 84 and an angled portion 86. An upper end 88 of the elongated portion 84 is attached to a generally “C”-shaped bracket 90 in cross-section transverse to a longitudinal axis of the elongated portion 84 for pivotally connecting to an end member 92 disposed at an upper end 94 of the second linkage section 32. A pair of bracket apertures 96 disposed on both sides of the bracket 90 is configured for receiving a transverse threaded fastener 98, such as a bolt.

A stiffener 100 is attached to the upper end 88 of the elongated portion 84 and the angled portion 86, and the stiffener is extending outwardly vertically from an outer surface 102 of the upper end of the elongated portion 84 and the angled portion 86. Preferably, the stiffener 100 continues from the upper end 88 of the elongated portion 84 to an entire length of the angled portion 86 to help resisting the compressive and bending loads of gravity when the first and second linkage sections 30, 32 are unfolded and extended.

A biasing member 104 is attached to the angled portion 86 such that the biasing member biases upon a spring 106 that is attached to the upper end 94 of the second linkage section 32. In a preferred embodiment, a polyurethane spring material is used as the spring 106 to provide a shock absorbing property. Also attached to the biasing member 104 are a linkage lock 108 and a pair of hook stops 110. One end of the biasing member 104 biases against the spring 106, and the other end of the biasing member is connected to the linkage lock 108.

As the linkage lock 108 bears down near the upper end 94 of the second linkage section 32 when the first and second sections 30, 32 are fully unfolded, the pair of hook stops 110 disposed on opposite sides of the biasing member 104 correspondingly snap over a pair of posts 112 extending laterally on opposite sides of the upper end 94 of the second linkage section 32. As shown in FIG. 2, when all first and second linkage sections 30, 32 are securely locked, the linkage lock assembly 82 stops movement of the projector cart 14 and consistently maintains the distance between the projector 20 and the receiver 48.

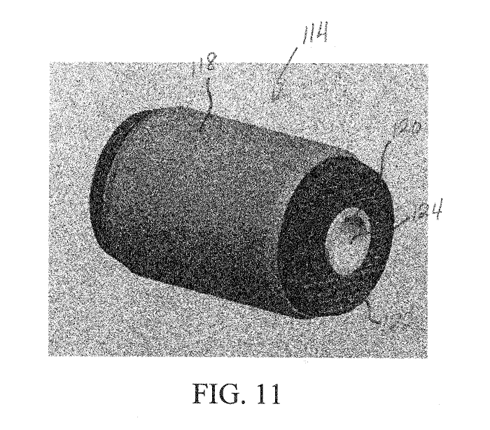

Referring now to FIGS. 2 and 9-11, an exemplary compliant joint, generally designated 114, is provided for allowing the pusher buggy assembly 28 to travel through curves and/or spirals on the railroad track and simultaneously limiting movement of the pivot joints 36 within a predetermined tolerance level. Specifically, the end member 92 of the second linkage section 32 has a bore 116 configured for receiving the compliant joint 114 that controllably minimizes pivotal and/or lateral movements caused by the geometry of the railroad track.

In the preferred embodiment, the compliant joint 114 includes an outer sleeve 118 surrounding an inner sleeve 120, both of which preferably have a cylindrical shape. An elastic material 122, such as a rubber, is disposed between the outer and inner sleeves 118, 120 for controlled movement. A center opening 124 configured for receiving the fastener 96 is defined by the inner sleeve 120.

As an example, the compliant joint 114 is slidably inserted into the bore 116 of the end member 92, and then the “C”-shaped bracket 90 of the first linkage section 30 fits over the end member. Connection of the compliant joint 114, the end member 92, and the “C”-shaped bracket 92 is achieved by fastening the fastener 98 through the bracket apertures 96 and the center opening 124. Accordingly, the compliant joint 114 provides the first linkage section 30 with not only radial pivoting movement but also lateral pivoting movement relative to the second linkage section 32. While only a specific type of compliant joint is described, other suitable compliant joints, such as various spherical bushings and slots, are also contemplated.

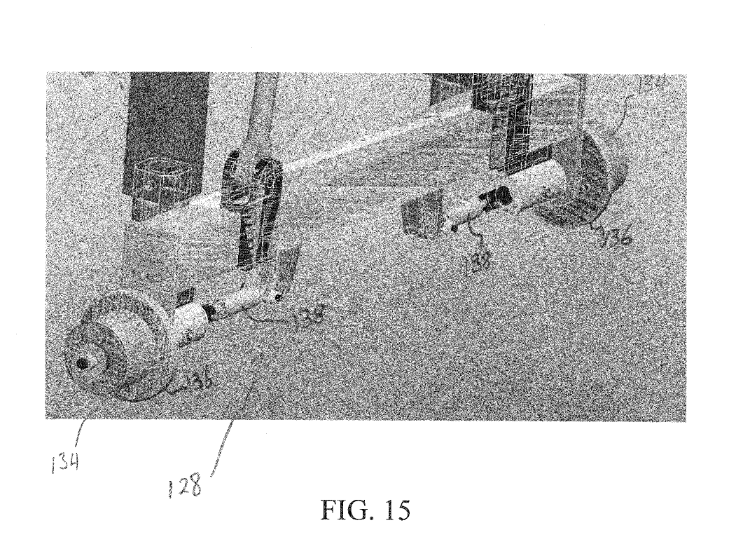

Referring now to FIGS. 2 and 12-15, the shadow board 26 is adjustable in multiple ways. When the rails have vertical or horizontal curves or dips, the shadow board 26 must be positioned accordingly to compensate for variations of the railroad track. For example, when calibrated, the shadow board 26 is moved until it occludes or blocks an infrared signal from the projector 20 such that the signal is not received by the receiver 48. When the track deviates laterally or vertically, the receiver 48 detects the infrared signal from the projector 20, and the tamper machine 50 corrects the rails to the desired position.

A positional adjustment of the shadow board 26 is achieved by a cage mount 126, which is connected at one end to the shadow board 26 and at an opposite end to a biasing wheels assembly, generally designated 128. Multiple cylinders 129, preferably hydraulic, are provided for actuating the cage mount 126 horizontally (left or right), vertically (up or down), and diagonally relative to the chassis 40. Notably, however, the cage mount 126 is not adjustable forwardly or rearwardly.

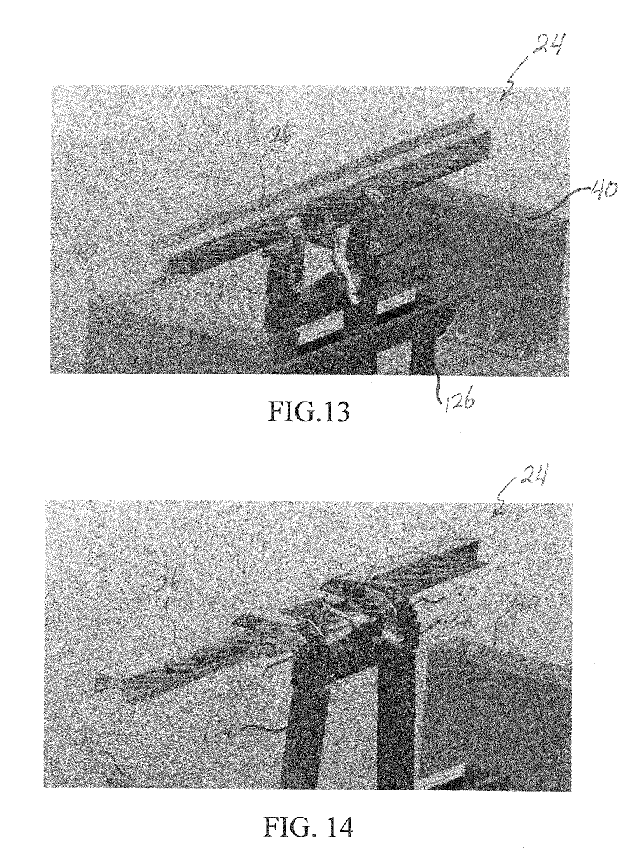

When the shadow board 26 is not in use or being transported, the board may be folded to comply with a highway height requirement. As shown in FIGS. 13-14, the shadow board 26 pivots downwardly or upwardly about a pair of pivot pins 130 under the action of an auxiliary cylinder 132, which is connected at one end to the shadow board 26 and at an opposite end to the cage mount 126. Accordingly, FIG. 13 shows the shadow board 26 in a work position, and FIG. 14 shows the shadow board in a travel position.

In operation, the shadow board buggy 24 is securely positioned relative to the rails for accurate surveys of the railroad track. For example, the biasing wheels assembly 128 includes a pair of biasing wheels 134. Each biasing wheel 134 has a flange 136 extending radially on an outer periphery of the wheel for biasing against an inner surface of each corresponding rail under the action of a spring-return hydraulic cylinder 138. While a single acting hydraulic actuator is described here, other types of cylinders, such as a dual acting cylinder, are also contemplated. Thus, the biasing wheels 134 are urged against inside surfaces of the rails to maintain the shadow board buggy 24 in position during track alignment.

Referring now to FIGS. 2 and 16-18, a detailed illustration of the receiver buggy 22 is shown. Multiple receivers are typically used for detecting the misalignment of the rails. In the preferred embodiment, a pair of surfacing receiver 140 is provided for detecting vertical misalignments of the rails. Each surfacing receiver 140 is mounted to an upper end 142 of a receiver support bar 144. A lower end 146 of the support bar 144 is inserted into an outer tube 148 of a sliding mount 150 such that the support bar slidably telescopes upwardly and downwardly within the outer tube.

Additionally, a pair of lining receivers 152 is also provided for detecting horizontal misalignments. Each lining receiver 152 is mounted to a lower end 154 of a vertical post 156. For generating the reference infrared signals, the projector 20 is provided for the pair of surfacing receivers 140, and similarly additional two side projectors (not shown) are provided for the corresponding lining receivers 152. In operation, the receivers 140, 152 simultaneously receive the infrared signals from the projectors.

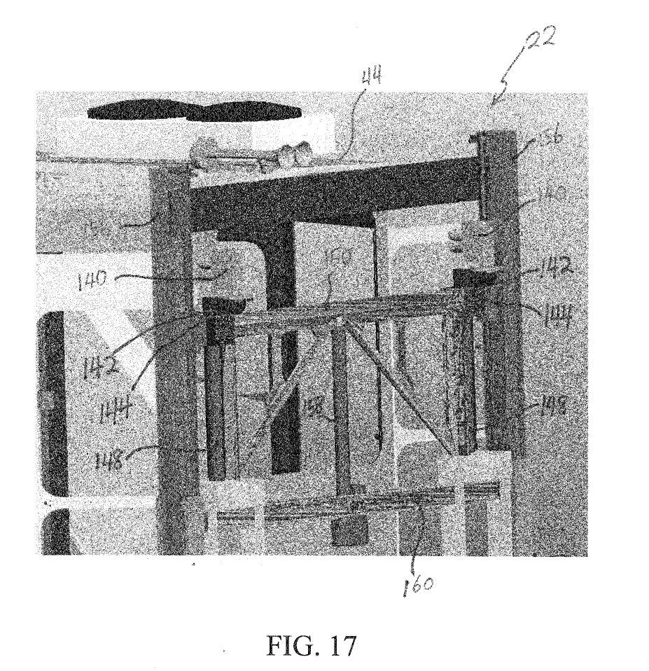

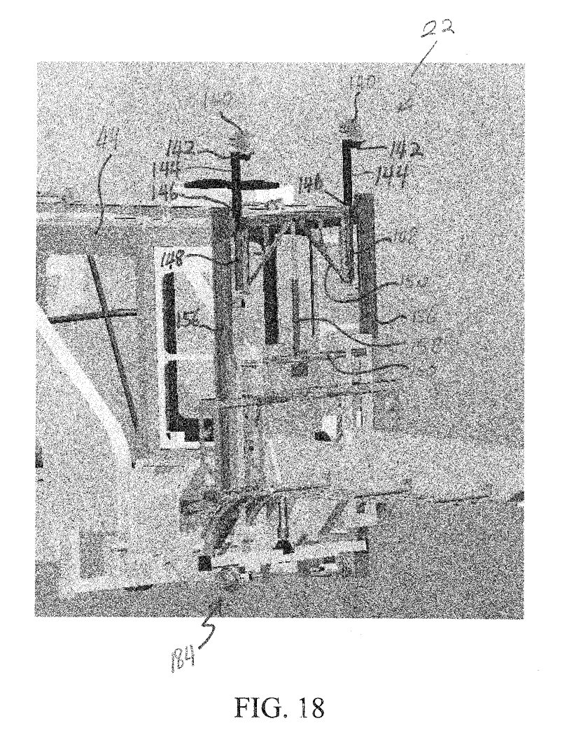

When the surfacing receivers 140 are not in use or being transported, the sliding mount 150 may be lowered to protect the receivers and/or to comply with the highway height requirement. As shown in FIGS. 17-18, for vertical movement of the sliding mount 150, a telescoping rod 158 is attached to at one end to the sliding mount 150 and at an opposite end to a horizontal support bar 160. Each end of the support bar 160 is connected to the vertical posts 156. For example, the sliding mount 150 slides upwardly to position the surfacing receivers 140 for detecting the infrared signals, and slides downwardly for storage during transportation.

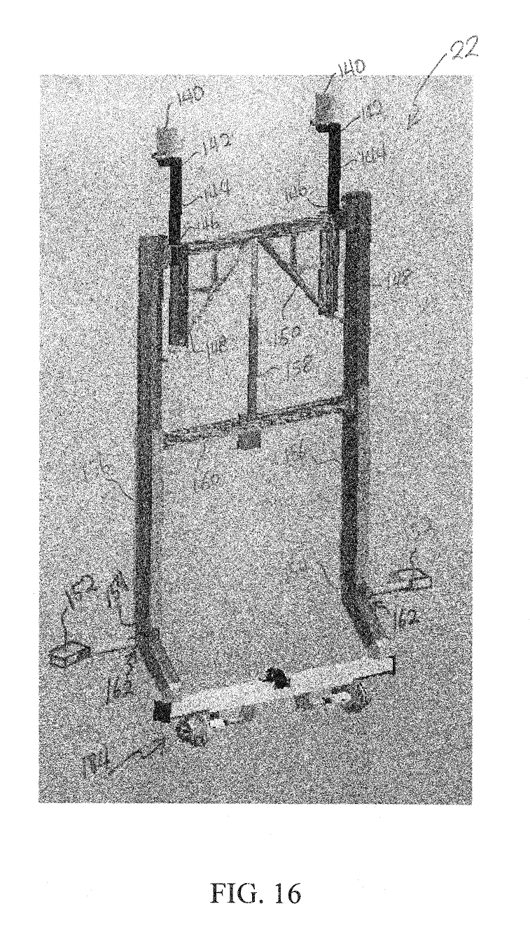

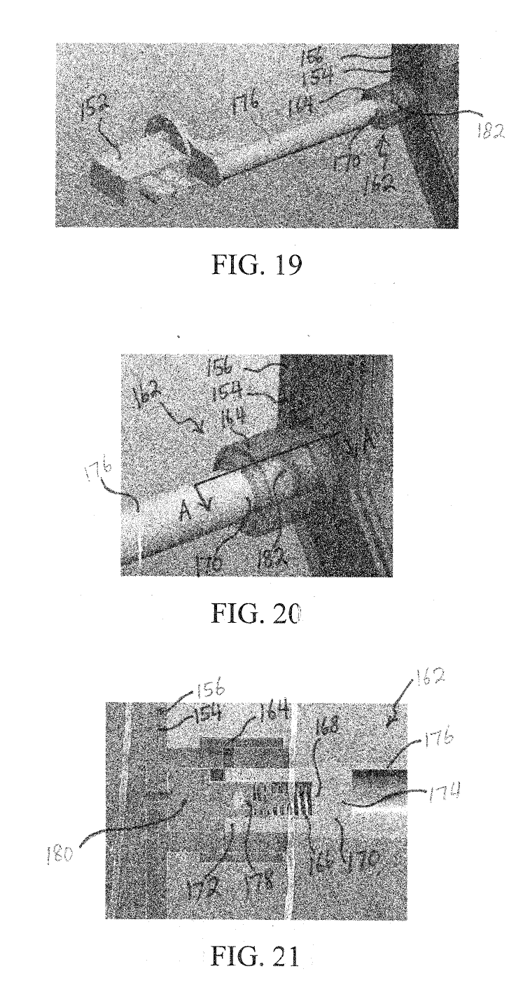

Referring now to FIGS. 16 and 19-21, a quick-release assembly, generally designated 162, is shown. As for the lining receivers 152, a width restriction for the track and/or the highway requires the lining receivers to be removed, folded, or retracted for clearance. In the preferred embodiment, the quick-release assembly 162 is provided for releasably securing the lining receiver 152 into a socket 164 configured for accommodating the lining receiver. Preferably, the socket 164 is fixedly attached to near or adjacent the lower end 154 of the vertical post 156 at a desired height. As best shown in FIGS. 19 and 21, a spring 166 is attached to an inner planar surface 168 of a tube 170 having an open end 172 and a closed end 174. A receiver support bar 176 is connected at one end to the closed end 174 of the tube 170, and at an opposite end to the lining receiver 152.

To attach the support bar 176 to the socket 164, the support bar is initially inserted into the socket against the action of the spring 166 guided by a guide pin 178, thereby depressing a spring plunger 180 while rotating the receiver clockwise at about 45 degree angle to lock the receiver in place with a locking protrusion 182. Conversely, to remove or release the lining receiver 152 from the socket 164, the receiver is slightly pushed into the socket, thereby depressing the spring plunger 180 again while rotating the receiver counterclockwise to unlock. As a result, the lining receiver 152 is released from the socket 164 and pulled out of the socket under the action of the spring 166 for storage.

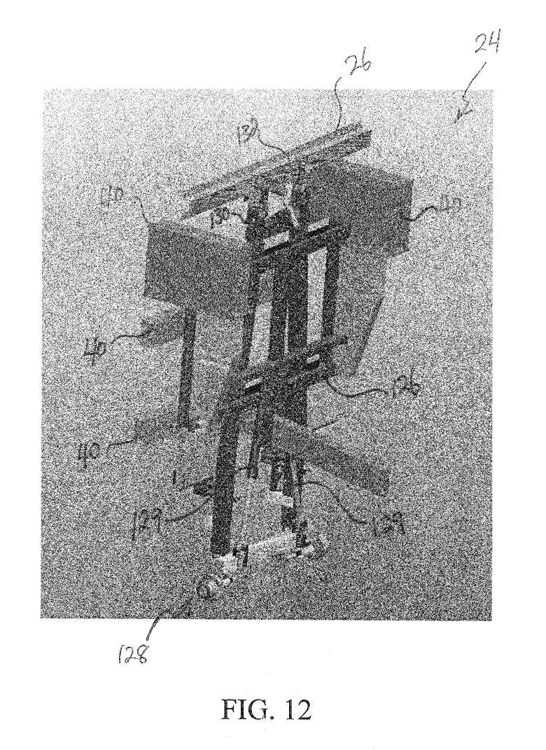

Returning now to FIGS. 12 and 15-16, as is the case with the shadow board buggy 24, the receiver buggy 22 also must be secured on the rails for accurate surveys of the railroad track. Accordingly, an additional biasing wheels assembly 184 similar to the biasing wheels assembly 128 illustrated above is provided and connected near the lower ends 154 of the vertical posts 156.

While a particular embodiment of the present railway reference machine has been described herein, it will be appreciated by those skilled in the art that changes and modifications may be made thereto without departing from the present disclosure in its broader aspects and as set forth in the following claims.

What is claimed is:

1. A railway reference machine for surveying and aligning a railroad track, comprising:
a collapsible projector assembly having a pusher buggy assembly, and a lifting device, a plurality of projectors being mounted to a projector cart, the pusher buggy assembly having extendable and retractable linkage sections such that the linkage sections are stackable and nestable within a space defined by the lifting device and the projector cart,
wherein at one end, the pusher buggy assembly is connected to the projector cart and at an opposite end is connected to the lifting device such that the projector cart pivots upwardly about a pivot point to rest the projector assembly in a space defined by a chassis being dimensional for supporting the reference machine, and pivots downwardly about the pivot point to lower the projector assembly on the railroad track.

2. The railway reference machine of claim 1, wherein the projector cart has a cart frame supported by a plurality of cart wheels for traveling on the track, and at least one beam transmitter is carried by the projector cart and mounted to the cart frame for projecting an infrared signal to a rearwardly located receiver buggy.

3. The railway reference machine of claim 1, further comprising a shadow board buggy being located between the projector assembly and a rearwardly located receiver buggy having at least one receiver.

4. The railway reference machine of claim 3, further comprising an adjustable shadow board being mounted to the shadow board buggy and provided in operational relationship to the projector assembly and the receiver buggy for indicating whether the track is out of alignment.

5. The railway reference machine of claim 4, wherein the plurality of projectors, the shadow board, and the at least one receiver establish a reference line to be used in correcting the track alignment relative to the reference line.

6. The railway reference machine of claim 1, further comprising a pusher buggy assembly including a first linkage section and a second linkage section, wherein at one end, the pusher buggy assembly is connected to the projector cart and at an opposite end is connected to the lifting device.

7. The railway reference machine of claim 6, wherein the first and second linkage sections are connected to each other and cause them to pivotally fold about a pivot point between the sections.

8. The railway reference machine of claim 6, wherein the pusher buggy assembly is extendable and retractable such that the first and second linkage sections are stackable upon and nestable within the lifting device.

9. The railway reference machine of claim 6, wherein the projector assembly transitions between a retracted mode and an extended mode, the retracted mode referring to a condition where the pusher buggy assembly is folded and securely stored on a base plate of the projector cart, and the extended mode referring to a condition where the pusher buggy assembly is unfolded and the first and second linkage sections are securely locked.

10. The railway reference machine of claim 1, wherein the projector assembly transitions to a road travel mode for being transported on a road, the road travel mode referring to a condition where the pusher buggy assembly is folded and stored in a space defined by the lifting device.

11. The railway reference machine of claim 10, wherein the projector assembly transitions to a track travel mode, which refers to a condition where the folded pusher buggy assembly is still stored in the projector cart, but the projector cart is lowered and movable on the track for transportation.

12. The railway reference machine of claim 1, wherein a lifting cylinder is connected at one end to the lifting device and at an opposite end to the chassis for pivoting movement of the pusher buggy assembly.

13. The railway reference machine of claim 2, further comprising a travel lock being connected at one end to a stand structure of the projector cart and at an opposite end to the cart frame, and configured to prevent movement of the pusher buggy assembly during transportation or storage.

14. The railway reference machine of claim 13, wherein a plurality of indentations are defined on a lower edge of the travel lock, and each indentation matingly biases an axle connected to a pair of pusher wheels of each second linkage section.

15. The railway reference machine of claim 6, further comprising a linkage lock assembly configured for securing the first and second linkage sections to ensure and maintain a constant distance between the linkage sections from one end of the first linkage section to the other opposite end of the second linkage section when fully extended.

16. The railway reference machine of claim 6, wherein a compliant joint is inserted into an end member of the second linkage section for allowing the pusher buggy assembly to travel through curves or spirals on the railroad track and simultaneously limiting movement of pivot joints between the first and second linkage sections within a predetermined tolerance level.

17. A railway reference machine for surveying and aligning a railroad track, comprising:
a collapsible projector assembly including a projector cart having at least one projector, a pusher buggy assembly, and a lifting device, the pusher buggy assembly transitions between a retracted mode and an extended mode, the retracted mode referring to a condition where the pusher buggy assembly is folded and securely stored on a base plate of the projector cart, and the extended mode referring to a condition where the pusher buggy assembly is unfolded on the railroad track,
wherein at one end, the pusher buggy assembly is connected to the projector cart and at an opposite end is connected to the lifting device such that the projector cart pivots upwardly about a pivot point to rest the projector assembly in a space defined by a chassis being dimensional for supporting the reference machine, and pivots downwardly about the pivot point to lower the projector assembly on the railroad track.

18. The railway reference machine of claim 17, further comprising a shadow board buggy having an adjustable shadow board being located between the projector assembly and a rearwardly located receiver buggy having at least one receiver for detecting misalignment of the track,
wherein a positional adjustment of the shadow board is achieved by a cage mount being connected at one end to the shadow board and at an opposite end to a biasing wheels assembly.

19. The railway reference machine of claim 18, wherein the shadow board pivots downwardly or upwardly about a pair of pivot pins under the action of an auxiliary cylinder being connected at one end to the shadow board and at an opposite end to the cage mount.

20. A railway reference machine for surveying and aligning a railroad track, comprising:
a collapsible projector assembly including a projector cart having at least one projector, a pusher buggy assembly, and a lifting device, the pusher buggy assembly being folded and securely stored on a base plate of the projector cart for storage or transportation, and being unfolded on the railroad track for operation,
wherein at one end, the pusher buggy assembly is connected to the projector cart and at an opposite end is connected to the lifting device such that the projector cart pivots upwardly about a pivot point to rest the projector assembly in a space defined by a chassis being dimensional for supporting the reference machine, and pivots downwardly about the pivot point to lower the projector assembly on the railroad track; and
a shadow board buggy having an adjustable shadow board being located between the projector assembly and a rearwardly located receiver buggy having at least one receiver for detecting misalignment of the track,
wherein a pair of surfacing receiver is provided for detecting vertical misalignments of rails, and a pair of lining receivers is provided for detecting horizontal misalignments of the rails.
